(19) United States
(12) Patent Application Publication
(10) Pub. No.: US 2006/0127185 A1
(43) Pub. Date: Jun. 15, 2006

(54) Alternative cover material for landfills

(75) Inventor: Lisa M. Fauteux, Epsom, NH (US)

Correspondence Address: WILMER CUTLER PICKERING HALE AND DORR LLP, THE WILLARD OFFICE BUILDING, 1455 PENNSYLVANIA AVE, NW, WASHINGTON, DC, 20004, US

(73) Assignee: Casella Waste Systems, Inc., Rutland, VT (US)

(21) Appl. No.: 11/011,614

(22) Filed: Dec. 15, 2004

(51) Int. Cl. B09B 5/00

(52) U.S. Cl. 405/129.9

(57) ABSTRACT

The invention provides an alternative cover material for landfills. The alternative cover material may comprise one or more of virgin contaminated soil, waste oil contaminated soil, asphalt emulsion, coal ash and asphalt shingles.

### FIELD OF THE INVENTION

The invention provides an alternative cover material for landfills.

### BACKGROUND OF THE INVENTION

State and federal environmental regulations require operators of certain types of landfills to cover exposed solid waste, typically at the end of each working day or at the end of every 24 hours. The daily cover is used to prevent vectors accessing the waste, odors, blowing, litter, fugitive dust emissions, and other nuisances. Daily cover material is also required to prevent fires and to allow loaded vehicles to successfully maneuver on the landfill after the cover material has been placed. Generally, the layer of cover material is required to be a minimum of 6 inches thick and a supply of the cover must be maintained on site. The daily cover requirements vary somewhat from state to state, but the material used is generally known in the industry as “daily cover” or “periodic cover” when the required interval is more than one day. As used herein “daily cover” is intended to include both daily and periodic cover for landfills such as municipal solid waste (MSW) landfills, construction and demolition debris (C&D) landfills, land clearing debris landfills, special waste, and industrial waste landfills.

Generally, each day's solid waste, garbage or other debris which has been placed in the landfill is covered at the end of the day. Further layers of solid waste, garbage and/or debris are then spread directly on top of the daily cover from the previous day. Typically, landfills use soil as a daily cover, and the soil must be purchased from an outside source and delivered to the landfill site. Due to the high rate of soil consumption as daily cover, and is some areas the lack of soil resources for this purpose, this can be a substantial cost item. Moreover, the soil used as a daily cover in the landfill uses a significant amount of the available landfill space which might otherwise be used for receiving solid waste garbage and debris. In addition, this practice poses a burden on existing, natural earthen resources which could otherwise be used for more valuable purposes, or remain safe from excavation. In view of the fact that landfill capacity is being rapidly exhausted, it would be desirable to reduce the consumption rate of the available landfill volume. It would also be desirable to use material which would otherwise be deposited in landfills as waste, as a component of an alternate daily cover material which meets all of the requirements for a daily cover, and can be provided at reduced cost. This would consume less overall landfill space since the materials would form part of the daily cover as opposed to part of the solid waste or debris which was previously required to be covered. The invention is directed to these, as well as other, important end.

### SUMMARY OF THE INVENTION

The invention provides products comprising (i) virgin petroleum contaminated soil and/or waste oil contaminated soil, and (ii) an asphalt emulsion. The product may optionally further comprise one or more of coal ash and asphalt shingles. The product may be used as an alternative cover material for landfills.

The invention provides landfills comprising waste and a cover material over the waste; wherein the cover material comprises (i) virgin petroleum contaminated soil and/or waste oil contaminated soil, and (ii) an asphalt emulsion. The cover material may optionally further comprise one or more of coal ash and asphalt shingles. The waste may contain construction and demolition material.

The invention provides methods for making landfill cover materials by mixing virgin petroleum contaminated soil and waste oil contaminated soil to obtain a blended product; and adding an asphalt emulsion to the blended product to produce the landfill cover material. Coal ash and/or asphalt shingles can be added prior to blending the virgin petroleum contaminated soil and waste oil contaminated soil; after blending the virgin petroleum contaminated soil and waste oil contaminated soil; or after adding the asphalt emulsion to the blended product.

The invention provides methods for making landfill cover materials comprising adding an asphalt emulsion to virgin petroleum contaminated soil and/or waste oil contaminated soil to produce the landfill cover material. The method may further comprise adding coal ash and/or asphalt shingles to make the landfill cover material. The coal ash and/or asphalt shingles may be added before or after the emulsion is added to or mixed with the virgin petroleum contaminated soil and/or waste oil contaminated soil.

The invention provides products comprising virgin petroleum contaminated soil and at least one of coal ash and asphalt shingles. The product may be used as an alternative cover material for landfills.

These and other aspects of the invention are described herein.

### DETAILED DESCRIPTION OF THE INVENTION

The invention provides novel alternative cover materials for landfills. The overall permeability of the landfill cover material of the invention is generally much less than typical cover material. The cover material of the invention has reduced permeability which provides an added benefit of reducing the amount of moisture and rainwater that is allowed to permeate the cover and percolate through the landfill waste mass, thus allowing a substantial decrease in landfill leachate generation. In addition, the landfill cover material of the invention adds structural integrity and stability to the landfill surface, allowing the safe travel of vehicles over the landfill face, and a reduction in potential erosion and siltation issues.

The invention provides products comprising (i) virgin petroleum contaminated soil and (ii) an asphalt emulsion. In other embodiments, the invention provides products comprising (i) virgin petroleum contaminated soil, (ii) an asphalt emulsion, and (iii) coal ash. In other embodiments, the invention provides products comprising (i) virgin petroleum contaminated soil, (ii) an asphalt emulsion, and (iii) asphalt shingles. In still other embodiments, the invention provides products comprising (i) virgin petroleum contaminated soil, (ii) an asphalt emulsion, (iii) coal ash, and (iv) asphalt shingles. The product may be used as a landfill cover material.

The invention provides products comprising (i) waste oil contaminated soil and (ii) an asphalt emulsion. In other embodiments, the invention provides products comprising (i) waste oil contaminated soil, (ii) an asphalt emulsion, and (iii) coal ash. In other embodiments, the invention provides products comprising (i) (ii) waste oil contaminated soil, (ii) an asphalt emulsion, and (iii) asphalt shingles. In still other embodiments, the invention provides products comprising (i) waste oil contaminated soil, (ii) an asphalt emulsion, (iii) coal ash, and (iv) asphalt shingles. The product may be used as a landfill cover material.

The invention provides products comprising (i) virgin petroleum contaminated soil, (ii) waste oil contaminated soil, and (iii) an asphalt emulsion. In other embodiments, the invention provides products comprising (i) virgin petroleum contaminated soil, (ii) waste oil contaminated soil, (iii) an asphalt emulsion, and (iv) coal ash. In other embodiments, the invention provides products comprising (i) virgin petroleum contaminated soil, (ii) waste oil contaminated soil, (iii) an asphalt emulsion, and (iv) asphalt shingles. In still other embodiments, the invention provides products comprising (i) virgin petroleum contaminated soil, (ii) waste oil contaminated soil, (iii) an asphalt emulsion, (iv) coal ash, and (v) asphalt shingles. The product may be used as a landfill cover material.

The invention provides products comprising (i) virgin petroleum contaminated soil and (ii) coal ash. In another embodiment, the invention provides products comprising (i) virgin petroleum contaminated soil and (ii) asphalt shingles. In another embodiment, the invention provides products comprising (i) virgin petroleum contaminated soil, (ii) coal ash and (iii) asphalt shingles. The product may be used as a landfill cover material.

Virgin petroleum contaminated soil refers to soil that comprises virgin petroleum. Virgin petroleum includes unused petroleum distillates. Waste oil contaminated soil refers to soil that comprises waste oil. Waste oil refers to petroleum distillates that are unsuitable for their original purpose due to the presence of impurities or the loss of original properties, e.g., as a result of use, storage, or handling. Exemplary petroleum distillates include gasoline, diesel, kerosene, jet fuel, No. 2 heating oil, No. 4 heating oil, No. 5 heating oil, No. 6 heating oil, and industrial oil (e.g., lubricating oil, hydraulic oil, crankcase oil, penetrant oil, tramp oil, quench oil and the like). The soil described herein may comprise other contaminants.

The asphalt emulsion comprises asphalt, water, and one or more emulsifying agents. The asphalt emulsion may be anionic, cationic or nonionic. In one embodiment, the asphalt emulsion is anionic. The asphalt emulsion may be rapid set, medium set, slow set or quick set. In one embodiment, the asphalt emulsion is slow set. In one embodiment, the asphalt emulsion may be RS-1, RS-2, CRS-1, CRS-2, HFRS-2, MS-1, HFMS-1, CMS-2, CMS-2h, MS-2, MS-2h, HFMS-2h, HFMS-2s, SS-1h, SS-1, CSS-1h, CSS-1 or a mixture of two or more thereof. In another embodiment, the asphalt emulsion may be SS-1h, SS-1, CSS-1h, CSS-1 or a mixture of two or more thereof. In one embodiment, the asphalt emulsion is SS-1 and/or SS-1h.

Coal ash may be any known in the art. Exemplary types of coal ash include fly ash, bottom ash, boiler slag and the like. The fly ash may be Class C or Class F.

Asphalt shingles are well known in the art. The asphalt shingles may be whole or in fragments. Fragments of asphalt shingles may be any size.

In one embodiment, the virgin petroleum contaminated soil and/or waste oil contaminated soil are screened to about 5 inch minus; to about 3 inch minus or to about 2 inch minus. In another embodiment, the virgin petroleum contaminated soil and/or waste oil contaminated soil are blended with coal ash and/or asphalt shingles, and then screened to about 5 inch minus; to about 3 inch minus; or to about 2 inch minus. In another embodiment, the virgin petroleum contaminated soil and/or waste oil contaminated soil are screened to about 5 inch minus (about 3 inch minus, or about 2 inch minus), and are then blended with coal ash and/or asphalt shingles.

The term “blended mix” comprises (i) petroleum contaminated soil, (ii) waste oil contaminated soil or (iii) petroleum contaminated soil and waste oil contaminated soil. The blended mix of virgin petroleum contaminated soil and/or waste oil contaminated soil and, optionally, coal ash and/or asphalt shingles, are mixed with the asphalt emulsion at ambient temperatures. Generally about 1 to about 25 gallons of asphalt emulsion may be used per ton of the blended mix. In other embodiments, about 1 to about 10 gallons, or about 1 to about 5 gallons of asphalt emulsion may be used per ton of the blended mix. The resulting product may comprise about 1 to about 10% by weight asphalt emulsion; about 1 to about 5% by weight asphalt emulsion; or about 1 to about 3% by weight asphalt emulsion. With respect to the total weight percentage of the contaminated soil in the blended mix, the virgin petroleum contaminated soil may be used in an amount from about 1% to about 99% by weight and the waste oil contaminated soil may be used in an amount from about 99% to about 1% by weight. In other embodiments, the virgin petroleum contaminated soil may be used in an amount from about 5% to about 95% by weight and the waste oil contaminated soil may be used in an amount from about 95% to about 5% by weight. In other embodiments, the virgin petroleum contaminated soil may be used in an amount from about 10% to about 90% by weight and the waste oil contaminated soil may be used in an amount from about 90% to about 10% by weight.

The resulting product may be used as an alternative daily cover material for landfills. The degradation of construction and demolition debris materials, either whole or in processed form, produces odors associated with the generation of hydrogen sulfide gas. It has been unexpectedly discovered that the alternative daily cover material of the invention reacts to ameliorate the emission of the hydrogen sulfide gas, and also generally caps and buffers the remaining gas generation. Accordingly, the landfill cover material of the invention is particularly useful in landfills that contain construction and demolition debris material, particularly ground C&D fines that may have been used at the landfill for grading and shaping material or as an alternative daily cover material. The landfill cover of the invention may be used in place of traditional landfill covers, as described herein.

While certain embodiments and details have been shown for the purpose of illustrating the invention, it will be apparent to one skilled in the art that various changes and modifications may be made without departing from the spirit or scope of the invention.

1. A product comprising waste oil contaminated soil, and an asphalt emulsion.

2. The product of claim 1, further comprising (a) coal ash, (b) asphalt shingles, or (c) coal ash and asphalt shingles.

3. The product of claim 1, wherein the emulsion is anionic.

4. The product of claim 1, wherein the emulsion is a slow set emulsion.

5. The product of claim 1, wherein the emulsion is SS-1 or SS-1h.

6. The product of claim 1, wherein the emulsion is SS-1h.

7. The product of claim 1, wherein the emulsion is present in the product in an amount of about 1% to about 5% by weight.

8. The product of claim 1, wherein the emulsion is present in the product in an amount of about 1% to about 3% by weight.

9. A landfill comprising waste and a cover material over the waste; wherein the cover material comprises waste oil contaminated soil, and an asphalt emulsion.

10. The landfill of claim 9, wherein the cover material is at least 6 inches thick.

11. The landfill of claim 9, wherein the waste comprises construction and demolition material.

12. A system comprising:
landfill comprising solid waste; and
a mixture comprising waste oil contaminated soil and an asphalt emulsion that covers the solid waste.

13. The system of claim 12, wherein the waste oil contaminated soil is screened to about 3 inches minus.

14. The system of claim 12, wherein the mixture further comprises at least one of (a) coal ash, and (b) asphalt shingles.

15. The system of claim 12, wherein the landfill further comprises construction and demolition debris, and the mixture ameliorates the emission of hydrogen sulfide gas produced by the degradation of the construction debris material.

16. The system of claim 12, wherein the mixture caps and buffers gas generation from the solid waste.

17. A method of covering a landfill with a mixture comprising:
obtaining waste oil contaminated soil;
creating the mixture by adding an asphalt emulsion to the waste oil contaminated soil; and
placing the mixture over a quantity of solid waste within a landfill.

18. The method of claim 17, further comprising screening the waste oil contaminated soil to about 3 inches minus.

19. The method of claim 17, wherein the mixture ameliorates emissions of hydrogen sulfide gas.

20. The method of claim 17, further comprising adding at least one of coal ash and asphalt shingles to the mixture.
